(19) United States
(12) Patent Application Publication
(10) Pub. No.: US 2011/0211546 A1
(43) Pub. Date: Sep. 1, 2011

(54) Transmitting Scheduling Request with Multiple Antennas

(76) Inventors: Kari Juhani Hooli, Oulu (FI); Kari Pekka Pajukoski, Oulu (FI); Esa Tapani Tiirola, Kempele (FI)

(21) Appl. No.: 13/127,135

(22) PCT Filed: Nov. 3, 2008
(86) PCT No.: PCT/EP2008/064872

§ 371 Date: May 2, 2011

(51) Int. Cl. H04W 72/04

(52) U.S. Cl. 370/329

(57) ABSTRACT

There is provided a solution for transmitting a scheduling request on a physical uplink control channel (PUCCH) using multiple antennas with spatial transmit diversity, each antenna group including one or more antenna elements. There is also provided a solution for receiving control information on the physical uplink control channel separately from one or more resources, determining whether specific resources are occupied with control information, combining specific PUCCH resources and deciding on whether to schedule the transmitter of the control information for an uplink transmission or not.

### FIELD

The invention relates generally to a transmission of a scheduling request in an uplink transmission. More particularly, the invention relates to transmitting scheduling request with multiple antennas on a physical uplink control channel (PUCCH).

### BACKGROUND

There is an ongoing effort to increase data rates in a mobile communication network. One possible solution for achieving desired high data rates is to use multiple antennas at both or at one of a transmitter and a receiver. For example, it is commonly understood that a single user multiple-input multiple-output (SU-MIMO) with two or up to four transmission antennas will be employed in one realization of a Long Term Evolution Advanced (LTE-A). LTE-A is the next step from LTE and fulfils the requirements of the fourth generation (4G) communication network as specified by the International Telecommunications Union (ITU). The LTE on the other hand is the next step from a universal mobile telecommunications system (UMTS).

LTE-A applies a physical uplink control channel (PUCCH) to transmit control signals, such as an acknowledgement (ACK)/negative-ACK (NACK), a channel quality indicator (CQI) and a scheduling request (SR) indicator, from a user equipment (UE) to an evolved node B (eNB). The SR indicator contains two states in which the UE either requests (positive SR indicator) or does not request (negative SR indicator) to be scheduled for uplink data transmission.

One challenge regarding the PUCCH is how to arrange the support of the PUCCH in the case when the UE is employed with multiple antennas. This includes optimizing the performance and the multiplexing capacity of the PUCCH. In general, the UE can employ a periodic SR resource and an on-demand ACK/NACK resource for transmitting control signals to the eNB. A collision may occur when the UE needs to transmit both ACK/NACK and the positive SR simultaneously. Prior art provides solution for a single antenna case: when both ACK/NACK and SR are transmitted, the UE shall transmit the ACK/NACK on its assigned ACK/NACK resource for a negative SR transmission, and transmit the ACK/NACK on its assigned SR resource for a positive SR transmission. However, this technique is not optimized for a transmission with multiple antennas.

### BRIEF DESCRIPTION OF THE INVENTION

An object of the invention is to provide a solution for transmitting a scheduling request from multiple antennas with spatial transmit diversity.

According to an aspect of the invention, there are provided methods as specified in claims 1 and 10.

According to an aspect of the invention, there are provided apparatuses as specified in claims 14, 23, 27 and 28.

According to an aspect of the invention, there are provided computer program products as specified in claims 29 and 30.

Embodiments of the invention are defined in the dependent claims.

### LIST OF DRAWINGS

In the following, the invention will be described in greater detail with reference to the embodiments and the accompanying drawings, in which

FIG. 1 presents a network architecture of the LTE;

FIG. 2 shows a use of power amplifiers according to an embodiment of the invention;

FIG. 3 illustrates a signaling procedure for transmitting an SR indicator with spatial transmit diversity, according to an embodiment of the invention;

FIG. 4 illustrates a signaling procedure for transmitting an ACK/NACK indicator with spatial transmit diversity, according to an embodiment of the invention;

FIG. 5 illustrates a block diagram of an apparatus according to an embodiment of the invention;

FIG. 6 shows a block diagram of an apparatus according to an embodiment of the invention;

FIG. 7 presents a method for transmitting the scheduling request with multiple antennas; and

FIG. 8 shows a method for receiving control information on the physical uplink control channel.

### DESCRIPTION OF EMBODIMENTS

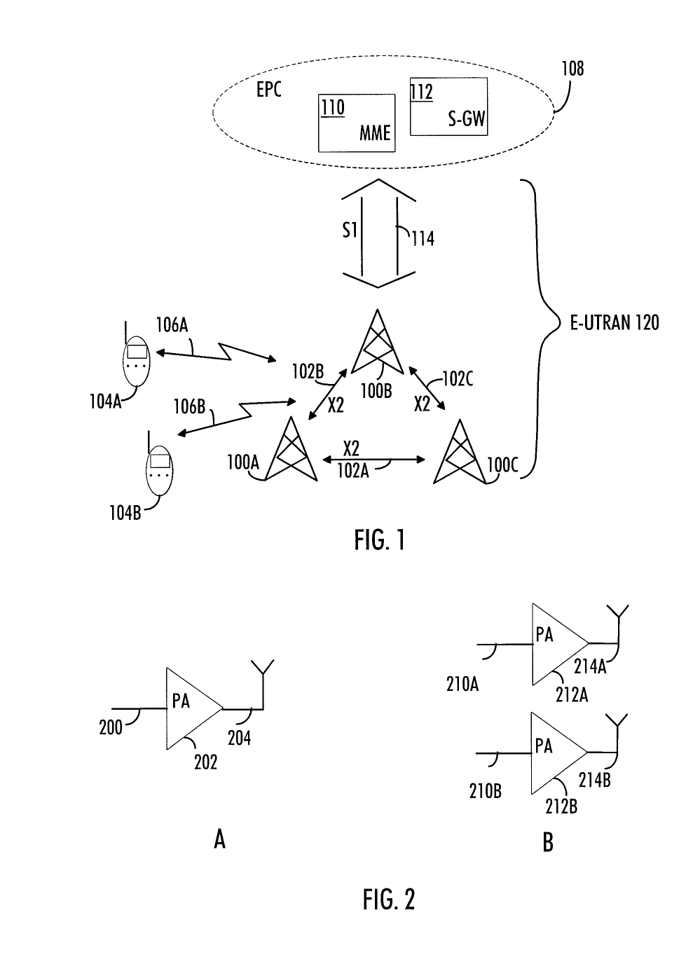

FIG. 1 illustrates a very general network architecture of the LTE in which the embodiments of the invention may be applied. The LTE is based on the release 8^{th} of the standardization work performed by a 3^{rd} Generation Partnership Project (3GPP). FIG. 1 shows only a very general architecture of the LTE network according to an embodiment of the invention. Thus, FIG. 1 shows only the elements and functional entities required for understanding the LTE architecture according to an embodiment of the invention. Other components have been omitted for the sake of simplicity. The implementation of the elements and functional entities may vary from that shown in FIG. 1. The connections shown in FIG. 1 are logical connections, and the actual physical connections may be different. It is apparent to a person skilled in the art that the LTE may also comprise other functions and structures. Although this invention is described using LTE as a basis, it could be applicable to any other wireless mobile communication system as well.

The LTE is enhanced with a new radio access technique called evolved UMTS terrestrial radio access network (E-UTRAN) 120. The E-UTRAN 120 consists of central nodes 100A to 100C, such as an evolved node B (eNB), which are interconnected by an X2 interfaces 102A to 102C. The central nodes 100A to 100C may be any apparatus capable of handling radio resource management and radio access control within a cell in which the apparatus provides coverage. The apparatus may thus be, for example, an eNB, a base station or a radio network controller (RNC). Therefore, the central nodes 100A to 100C may perform tasks related to resource management, admission control, scheduling and measurements related to channel quality.

The central nodes 100A to 100C may further interface with user equipments 104A to 104B via radio link connections 106A to 106B. The connections 106A to 106B may be either downlink connections or uplink connections.

Further, the LTE is accommodated with a new packet core architecture called an evolved packet core (EPC) 108 network architecture. Each eNB 100A to 100C is further connected to the EPC 108 by an S1 interface 114. The EPC may comprise, for example, a mobility management unit (MME) 119 and a service gateway (S-GW) 112. On a user plane the S1 interface 114 terminates to the S-GW 112, and on a signaling plane the S1 interface 114 terminates to the MME 110. Thus, the S-GW 112 guides and forwards user data packets, whereas the MME 110 handles control signaling related to user mobility. The EPC may comprise also other functionalities besides those related to the MME 110 and S-GW 112 but for reasons of simplicity they are not depicted in FIG. 1.

The physical layer of the LTE includes orthogonal frequency division multiple access (OFDMA) and multiple-input and multiple-output (MIMO) data transmission. For example, the LTE deploys the OFDMA for the downlink transmission and single carrier frequency division multiple access (SC-FDMA) for the uplink transmission. In OFDMA, the transmission frequency band is divided into multiple sub-carriers orthogonal to each other. Each sub-carrier may transmit data to a specific UE 104A to 104B. Thus, multiple access is achieved by assigning subsets of sub-carriers to individual UEs 104A to 104B. The SC-FDMA, on the other hand, is a type of discrete Fourier transform (DFT) pre-coded OFDMA scheme. It utilizes single carrier modulation, orthogonal frequency domain multiplexing and frequency domain equalization.

One issue that needs special attention in SC-FDMA relates to the peak to average power ratio (PAR), which describes the ratio of the peak power level to the time-averaged power level. Thus, for example, in the case when some sub-carriers are left empty, the average power level decreases and the PAR increases. In order to keep the PAR level low, only contiguous set of sub-carriers can be allocated at a given time instant. One of the requirements of SC-FDMA is to maintain the low PAR properties of the transmitted signal in all cases. The embodiments of the invention provide solutions for maintaining low PAR properties of the transmitted signal.

As explained in the background description, the LTE-A is the next step from LTE and fulfils the requirements of the 4 G communication network. The LTE-A provides the physical uplink control channel (PUCCH) as an uplink access link from the UE 104A to 104B to the central node 100A to 100C. The PUCCH may be used to transmit control information to the central node 100A to 100C indicating an acknowledgement (ACK)/a negative-ACK (NACK), a measure of a channel quality and/or a scheduling request (SR).

The PUCCH may be divided into different formats. Format 1 is generated for transmitting an un-modulated scheduling request indicator (SRI) indicating a need for the uplink transmission. The need for the uplink transmission may be due to data that has been buffered in the UE 104A, 104B and is waiting to be transmitted in the uplink transmission. Format 1a/1b of PUCCH is applied in transmission of ACK/NACK indicator only indicating correctness of a received downlink data. The ACK/NACK indicator may consist of one or two bits and it may be transmitted by means of modulated sequence. The modulation is obtained by means of binary phase shift keying (BPSK) or quadrature phase shift keying (QPSK). Further, the modulated ACK/NACK sequence may be affected by computer searched zero-autocorrelation (CAZAC) sequences. In addition, block spreading by using orthogonal codes may be performed on the sequence. Format 2/2a/2b denotes transmission of a periodic CQI and CQI+ACK/NACK indicator.

The embodiments of the invention provide multi-antenna signal handling arrangement at the UE 104A to 104B and at the central node 100A to 100C for format 1 PUCCH, by transmitting control information on the physical uplink control channel from multiple antenna groups with spatial transmit diversity, each antenna group comprising one or more antenna elements. The control information may comprise a scheduling request indicator, either a positive or negative, and an ACK/NACK indicator. Further, the embodiments provide solutions for simultaneous SRI and other control information transmission procedures with multiple antennas. The embodiments focus on open loop transmission procedures although closed loop transmission procedures with downlink signaling overhead on the physical downlink control channel (PDCCH) are not out of scope of the embodiments of the invention.

PUCCH may be seen, from a single UE's 104A, 104B point of view, as one resource block comprising 12 sub-carriers in a frequency domain and one sub-frame in a time domain. One sub-frame may be of a length of one ms and it may comprise of two transmission slots. Different UEs 104A, 104B may be multiplexed by means of FDM between the resource blocks and code division multiplexing (CDM) within a resource block. The CDM may be achieved by applying cyclic shifts of CAZAC sequences to the control information. That is, different UEs 104A, 104B may be accommodated by introducing individual cyclic shifts for each UE 104A, 104B. Different UEs 104A to 104B may also be accommodated by applying block-wise spreading with orthogonal spreading codes to the CAZAC affected sequences. The spreading code may be, for example, a Walsh-Hadamard code. This increases the multiplexing capacity by a factor of a spreading factor.

Let us next consider the embodiments of the invention in detail. FIG. 2 shows how to use power amplifiers in a transmission according to an embodiment of the invention. FIG. 2A illustrates a prior art solution in which the signal 200 to be transmitted is amplified with a single power amplifier (PA) 202 prior to transmitting the signal 200 from an antenna 204. The power amplifier 202 may amplify the signal 200 by, for example, 24 dBm. FIG. 2B illustrates a solution provided by an embodiment of the invention in which signals 210A, 210B to be transmitted from antennas 214A, 214B, respectively, are amplified with two 21 dBm power amplifiers 212A, 212B, respectively.

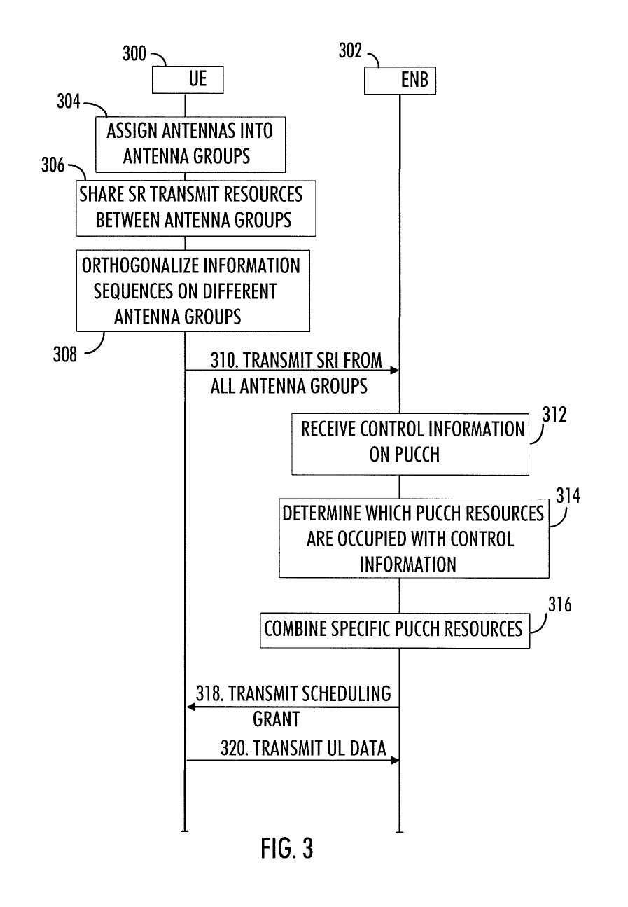

FIG. 3 illustrates a signaling procedure for transmitting the SRI from a UE 300 with spatial transmit diversity to the eNB 302, according to an embodiment of the invention. The UE 300 may recognize a need for transmitting data in the uplink transmission. For this reason, the UE 300 needs to inform the eNB 302 by transmitting the scheduling request indicator (SRI) to the eNB 300. According to the embodiment, the UE 300 is equipped with multiple transmit antenna elements. That is, the UE 300 may transmit control information on the PUCCH from multiple antenna groups with spatial transmit diversity.

The UE 300 assigns the multiple antenna elements into antenna groups in step 304, each antenna group comprising one or more antenna elements. The antenna groups may be formed virtually. That is, the antenna elements are not physically re-located. However, in terms of signal processing the antenna elements are divided into antenna groups. The assignment of the antenna elements into antenna groups may be performed arbitrarily. For example, if the UE 300 is equipped with two transmit antenna elements, the number of the antenna groups may also be two. However, if the UE 300 is equipped with, for example, four antenna elements, the number of the antenna groups may be anything from two to four. A possible way to divide the antenna elements into groups when the UE 300 is equipped with four antenna elements is to divide the antenna elements such that one antenna group has two antenna elements.

Further, the UE 300 may re-group (re-order) the antenna elements between transmission time slots. That is, the antenna groups may be formed separately for each transmission time slot. According to an embodiment, the UE 300 assigns one or more antennas that belonged to one antenna group in the previous transmission slot to another antenna group for the next transmission slot. This is illustrated in Table 1.

TABLE 1
Re-ordering of the antenna elements between transmission time slots.

| | Slot #0 | | Slot #1 | |
|---|---|---|---|---|
| | Antenna | Antenna | Antenna | Antenna |
| | group #1 | group #2 | group #1 | group #2 |
| Antenna #1 | x | | x | |
| Antenna #2 | x | | | x |
| Antenna #3 | | x | x | |
| Antenna #4 | | x | | x |

Further, the UE 300 may introduce a phase shift between antenna outputs within an antenna group for predetermined transmission slots in order to avoid negative correlation between the antenna elements. Further, the at least one antenna output to be phase shifted may be selected independently for each of the predetermined transmission slot. For example, half of the antenna element outputs of each antenna group may be phase shifted in the next transmission slot. This may be accomplished by using a phase rotator, e.g. with “−1” (180°) as shown in Table 2.

TABLE 2
Applying phase shift between antenna outputs within an antenna group.

| | Slot #0 | | Slot #1 | |
|---|---|---|---|---|
| | Antenna | Antenna | Antenna | Antenna |
| | group #1 | group #2 | group #1 | group #2 |
| Antenna #1 | 1 | | 1 | |
| Antenna #2 | 1 | | −1 | |
| Antenna #3 | | 1 | | 1 |
| Antenna #4 | | 1 | | −1 |

According to the embodiment, the UE 300 further shares a resource for the SRI between the antenna groups in step 306 in the case when there is no resource allocated for the positive/negative acknowledgement (ACK/NACK) indicator transmission. The resource for the SRI may be allocated periodically for the UE 300. The available transmission power is also shared among the antenna groups. The resource for the SRI may be, for example, one or more cyclic shifts and orthogonal codes (orthogonal cover codes) in the PUCCH resource block.

The UE 300 may apply additional orthogonal cover codes (e.g., [1,1] and [1,−1]) on top of existing orthogonal cover codes (Sequence 1, Sequence 2) to separate the control information being transmitted from different antenna groups in step 308. According to an embodiment illustrated in FIG. 3, the control information equals to the SRI. The additional orthogonalization is done in order to obtain orthogonal data sequences from different antennas/antenna groups and, therefore, an increased spatial transmit diversity. The additional orthogonal codes may be Walsh-Hadamard codes. The orthogonal cover code per transmission time slot to be transmitted may comprise the first sequence (Sequence 1, e.g., data signal part) and the second sequence (Sequence 2, e.g., reference signal part). The different parts may be separately coded with different orthogonal codes. Further, the data comprising the SRI and the reference signal part may be un-modulated, according to the embodiment.

The UE 300 transmits the SRI from all antenna groups using the shared resource for the SRI to the eNB 302 in step 310. According to the embodiment, the eNB 302 receives control information on one or more resources of the PUCCH associated with a transmitter in step 312. The one or more resources may be received from multiple transmission channels. The transmission channel may be understood as a transmission channel being used by one antenna group at the UE 300.

The eNB 302 determines whether specific resources of the physical uplink control channel are occupied with control information in step 314. The eNB 302 may check, for example, whether the resource for the SRI or the at least one resource for the ACK/NACK indicator is occupied with control information.

The eNB 302 may further combine the control information on specific resources when the specific resources are occupied with control information in step 316. The specific resources may be the one or more resources for the SRI or the one or more resources for the ACK/NACK indicator. That is, the eNB 302 may combine the control information on at least one of the following resources: the resources for the scheduling request indicator and the resources for the positive/negative acknowledgement indicator. According to the embodiment of FIG. 3, the eNB 302 combines the received SRI resources. The eNB 302 may perform separate channel estimation by applying different orthogonal codes for the control information (the SRI in this case) received from different resources of the PUCCH. The estimations and combinations may be performed separately for each received time slot. The combination of the different control data may be based on arithmetic operations, such as summing and/or averaging, performed on the separate channel estimates for the control information received from different transmission channels. Further, the eNB 302 may perform rotation means for the control information that has been phase shifted at the UE 300. The combination in step 316 may be performed prior to step 314 instead of being performed after it, if seen appropriate.

The eNB 302 decides on whether to schedule the transmitter of the control information for an uplink transmission or not, when a resource for the SRI is occupied with a control information. That is, according to the embodiment, the eNB 302 schedules the transmitter for the uplink transmission when the resource for the SRI is occupied with control information. Consequently, in step 314, the eNB notices that the resource for the SRI is occupied with control information. The eNB 302 may not need to know which control information is transmitted from the UE 300. However, the eNB 302 determines whether specific resources of the PUCCH are occupied and determines consequent actions based on that.

Thus, the eNB 302 may then transmit a scheduling grant to the UE 300 in step 318. The scheduling grant may assign the UE 300 an uplink resource, which the UE 300 can use in the uplink data transmission in step 320. However, the eNB 302 may decide not to grant uplink resources to the UE 300 in which case the functions marked with reference numbers 318 and 320 may not take place.

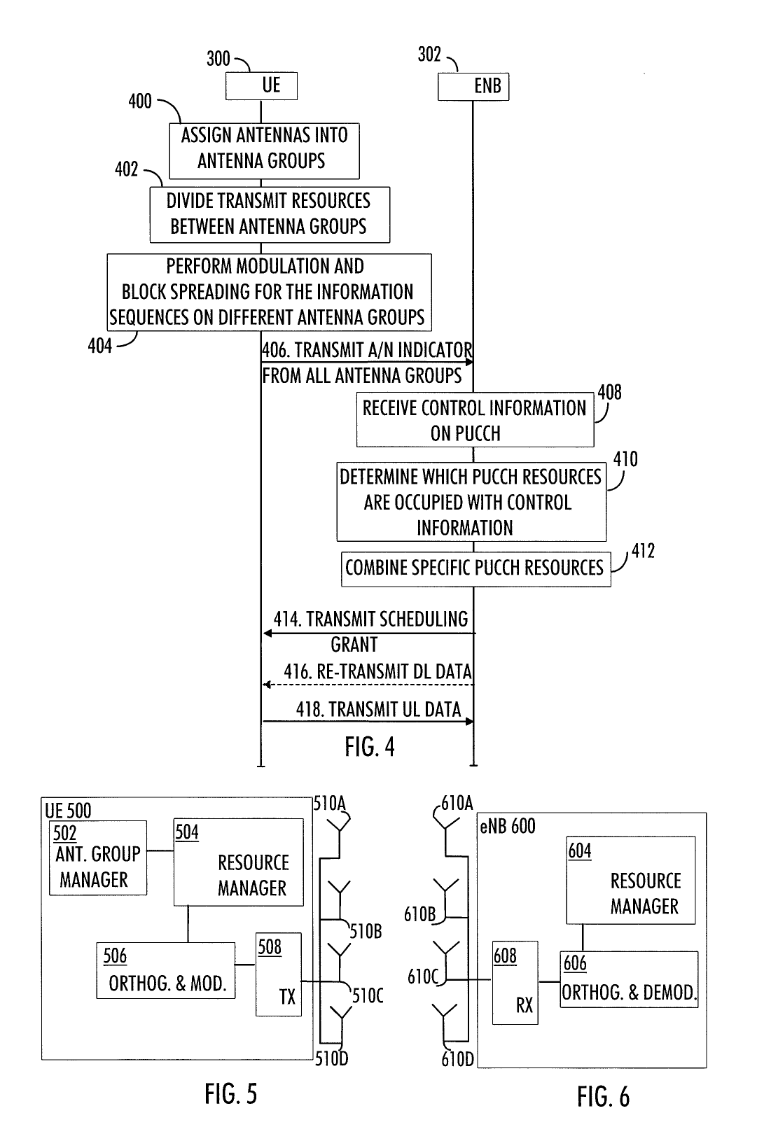

FIG. 4 illustrates a signaling procedure for transmitting the ACK/NACK indicator from the UE 300 with spatial transmit diversity to the eNB 302, according to an embodiment of the invention. That is, in this embodiment, the ACK/NACK indicator and the SRI exist simultaneously and the UE will thus have resources for the SRI and for the ACK/NACK indicator available.

Similarly to the embodiment described with FIG. 3, the embodiment described with FIG. 4 also begins by assigning the multiple antenna elements of the UE 300 to antenna groups in step 400, each group containing one or more antenna elements. The assignment of the antennas to groups may be performed as described earlier regarding Tables 1 and 2. However, in the embodiment of FIG. 4, the UE 300 transmits the ACK/NACK indicator to the eNB 302 instead of the SRI. Thus in a case of positive SRI, in step 402, the UE 300 divides the resources of the PUCCH such that at least one resource for the SRI is allocated to some antenna groups and at least one resource for the ACK/NACK indicator is allocated to other antenna groups. For example, in a case of two antenna groups, the first antenna group may be allocated with a resource for the SRI and the second antenna group may be allocated with a resource for the ACK/NACK indicator. The resource for the ACK/NACK indictor may be allocated to the UE 300 by the eNB 302 when the eNB 302 transmits downlink data to the UE 300. That is, the UE 300 may use the resource for the ACK/NACK indicator in indicating the eNB 302 was the downlink data received correctly or not. Thus, the UE 300 may request for re-transmission of the downlink data if the downlink data was not received correctly.

As explained earlier, in the case when the ACK/NACK indicator is transmitted, the ACK/NACK indicator may be transmitted by means of modulated sequence. Furthermore block spreading for the data part and for the reference signal part of the transmitted sequence may be applied in step 404. The data part of the sequence may be BPSK or QPSK modulated depending on how many bits the ACK/NACK indicator comprises. Other modulation methods may also be used if needed, comprising for example 16-quadrature amplitude modulation (QAM and 64-QAM. Modulation of the ACK/NACK indicator may be performed to a cyclically shifted CAZAC sequence. The cyclic shift is a UE 300 dependent cyclic shift to distinguish the UE 300 from different UEs. Using the orthogonal block spreading codes, with predetermined spreading factor values, may further be applied to the modulated ACK/NACK sequence. According to the embodiment, the procedures in step 404 are performed for the ACK/NACK indicator being sent from each antenna group, regardless which resource the antenna group uses.

The UE 300 transmits the ACK/NACK indicator from all antenna groups using the resources for the SRI with some antenna groups and resources for the ACK/NACK indicator with the other antenna groups in step 406. For example, the UE 300 may transmit the ACK/NACK indicator by using the resource for the ACK/NACK indicator from one antenna group indicating the correctness of the received downlink data, and the same ACK/NACK indicator by using the resource for the SRI from another antenna group indicating the need for the uplink transmission, in the case when there are two antenna groups. This way, the spatial transmit diversity for the ACK/NACK indicator is increased in comparison to prior art solutions. Further, the eNB 302 may receive knowledge about the uplink transmission need of the UE 300 and also about the need to possible re-transmission of data to the UE 300. In addition, the PAR is maintained due to occupied resource for the SRI. The transmission of the ACK/NACK indicator on the resource of the SRI may be conducted with similar methods as the transmission of the ACK/NACK indicator on the resource for the ACK/NACK indicator.

According to the embodiment, the eNB 302 may then receive control information (ACK/NACK indicator in this case) from one or more resources of a physical uplink control channel associated with the UE 300 in step 408, as explained regarding FIG. 3. Further, the eNB 302 determines whether specific resources of the physical uplink control channel are occupied with control information in step 410. The determined resources may comprise more than one resource for the ACK/NACK indicator, and more than one resource for the SRI indicator. The eNB 302 may check, for example, whether the resource for the SRI or the resource for the ACK/NACK indicator is occupied with control information.

The eNB 302 may further combine the control information on specific resources when the specific resources are occupied with control information in step 412. That is, the eNB 302 may combine the control information on at least one of the following resources: the resources for the positive/negative scheduling request indicator and the resources for a positive/negative acknowledgement indicator. According to the embodiment of FIG. 4, the eNB 302 may combine the control information on the resource for the SRI and on the at least one resource for the ACK/NACK indicator. The eNB 302 may perform separate channel estimation by applying different orthogonal codes for the control information received from different resources of the physical uplink control channel. The combination in step 412 may be performed prior to step 410 instead of being performed after it, if seen appropriate.

The eNB 302 decides on whether to schedule the transmitter of the control information for an uplink transmission or not. According to the embodiment, the eNB 302 schedules the transmitter for the uplink transmission when the resource for the SRI is occupied with control information. That is, in step 410, the eNB 302 may notice that the resource for the SRI is occupied with control information (ACK/NACK indicator) and transmit a scheduling grant to the UE 300 in step 414. As a result, the UE 300 may start transmitting uplink data to the eNB 302 in step 418. However, the eNB 302 may decide not to grant uplink resources to the UE 300 in which case the functions marked with reference numbers 414 and 418 may not take place.

Further, according to the embodiment of FIG. 4, the eNB 302 determines whether at least one resource for the ACK/NACK indicator is occupied with the control information or not. Once the eNB 302 acknowledges that the ACK/NACK resource is occupied with control information, the eNB 302 re-transmits downlink data to the UE 300 in step 416 when the received control information on the at least one resource for the ACK/NACK indicator indicates accordingly. For example, if the ACK/NACK indicator being transmitted on the resource for the ACK/NACK indicator is “0”, the eNB 302 re-transmits the data to the UE 300. However, if the ACK/NACK indicator being transmitted on the resource for the ACK/NACK indicator is “1”, the eNB 302 acknowledges that the data that has been transmitted to the UE 300 has been received correctly by the UE 300 and, therefore, there is no need to re-transmit the downlink data to the UE 300. In this case the action marked with reference number 414 may be omitted from FIG. 4. The mapping of the “1” and “0” may be performed vice versa also. Further, the ACK/NACK indicator may comprise more than one bit.

Moreover, the eNB 302 may re-transmit downlink data to the transmitter when each of the at least one allocated resource for the positive/negative acknowledgement is empty. That is, the UE 300 may have missed the downlink scheduling grant and the corresponding data transmitted for the UE 300 and, consequently, may not send the ACK/NACK indicator in the uplink transmission. Consequently, the eNB 302 may, even though having allocated a resource for the ACK/NACK indicator, receive an empty resource for the ACK/NACK indicator. This situation is called a discontinuous transmission (DTX) and it is important for the eNB 302 to detect this situation, or at least to prevent the situation in which the DTX is interpreted as an ACK at the receiver.

The eNB 302 may not need to know which control information is transmitted from the UE 300. However, the eNB 302 determines whether specific resources of the PUCCH are occupied and determines consequent actions on the basis of thereof. The order of the steps 414 to 418 may be changed in FIG. 4 according to the available resources between the UE 300 and the eNB 302.

Looking at FIGS. 3 and 4, it is clear that the UE 300 may determine whether there is at least one resource for the ACK/NACK indicator allocated for transmission or not. The UE 300 may then transmit the ACK/NACK indicator with spatial transmit diversity when the at least one resource for ACK/NACK indicator is allocated for transmission, as is the case in FIG. 4. Alternatively, the UE 300 may transmit the SRI with spatial transmit diversity when the at least one resource for ACK/NACK indicator is not allocated for transmission as is the case in FIG. 3.

In a case when the SRI need not to be transmitted, i.e. when the UE 300 need not to transmit uplink data to the eNB 302, the resource for the SRI may be left empty and the ACK/NACK indicator may be transmitted from all antenna groups using the resource of the ACK/NACK indicator. Similarly, the CQI may be transmitted from a CQI resource in the case when there is no need to transmit the scheduling request to the eNB 302. In the case when the UE 300 needs to transmit the SRI to inform the eNB 302 of the uplink data transmission simultaneously with periodic CQI transmission, the CQI may be dropped and procedures explained in connection with FIGS. 3 and 4 may be applied.

Table 3 clarifies the transmission of PUCCH resources from different antenna groups (two groups for reasons of simplicity) at different situations. The “x” denotes that PUCCH format 1 applies the resource, i.e. transmission of the SRI without the ACK/NACK indicator. The “y” denotes that PUCCH format 1a/1b applies the resource, i.e. transmission of the ACK/NACK indicator only. A blank box indicates that no resource can be applied. When two antenna groups simultaneously transmit control information, two resources may be applied. For example, the antenna group #1 may apply the resource for ACK/NACK indicator and the antenna group #2 may apply the resource for the SRI, or vice versa.

TABLE 3
Transmission of PUCCH resources.

| | | Resource for | | | |
|---|---|---|---|---|---|
| | | ACK/NACK | | Resource for SRI | |
| | | indicator applied | | indicator applied | |
| | Transmission | Antenna | Antenna | Antenna | Antenna |
| Transmission | of ACK/NACK | Group | Group | Group | Group |
| of SRI | indicator | #1 | #2 | #1 | #2 |
| No | Yes | y | y | | |
| | No | | | | |
| Yes | Yes | y | y | y | y |
| | No | | | x | x |

The ACK/NACK indicator may also comprise two information bits, in which case it may occupy multiple PUCCH resources. The UE may in this case transmit one ACK/NACK indicator by using a predetermined resource for the ACK/NACK indicator from one antenna group indicating the correctness of the received downlink data, and another ACK/NACK indicator by using the resource for the SRI from another antenna group indicating the correctness of the received downlink data and simultaneously the need for the uplink transmission.

Further, the UE may transmit the ACK/NACK indicator by using at least one resource for the ACK/NACK indicator from at least one antenna group, when the SRI is not transmitted (negative SRI). That is, when there is no need to transmit the scheduling request. This may occur, for example, when there is no data buffered for the uplink transmission. Table 4 illustrates the case when the UE transmits the ACK/NACK indicator occupying two resources from two antenna groups by using at least one resource for the ACK/NACK indicator. It can be seen from Table 4, that in the case of a negative SRI, the ACK/NACK indicator is transmitted by using the resources for the ACK/NACK indicator. In the case of a positive SRI, the ACK/NACK resource is transmitted by using the resource for the SRI and the at least one resource for the ACK/NACK indicator. The ACK/NACK+ may denote that the transmitter sends an ACK/NACK indicator indicating that the downlink data was received correctly. The ACK/NACK− may denote that the transmitter sends an ACK/NACK indicator indicating a need for re-transmission of the downlink data.

TABLE 4
Transmission of the ACK/NACK indicator when the
ACK/NACK indicator occupies two resources.

| | ACK/ | ACK/ | ACK/ | ACK/ |
|---|---|---|---|---|
| | NACK+, | NACK−, | NACK+, | NACK−, |
| Resource | SRI− | SR− | SRI+ | SRI+ |
| ACK/NACK | x | x | x | x |
| resource #1 | | | | |
| ACK/NACK | x | x | | |
| resource #2 | | | | |
| SRI resource | | | x | x |

FIG. 5 shows a block diagram of an apparatus according to an embodiment of the invention. The apparatus may be, for example, a UE 500. FIG. 6 illustrates a block diagram of an apparatus according to an embodiment of the invention. The apparatus may be, for example, an eNB 600. FIGS. 5 and 6 show only very general architectures of the UE 500 and the eNB 600 according to embodiments of the invention. Thus, FIGS. 5 and 6 show only the elements and functional entities required for understanding the architectures of the UE 500 and the eNB 600, according to an embodiment of the invention. Other components have been omitted for reasons of simplicity. The implementation of the elements and functional entities may vary from that shown in FIGS. 5 and 6. The connections shown in FIGS. 5 and 6 are logical connections, and the actual physical connections may be different. It is apparent to a person skilled in the art that the UE 500 and the eNB 600 may also comprise other functions and structures.

The UE 500 of FIG. 5 comprises an antenna group manager 502. The antenna group manager 502 takes care of assigning antenna elements to (virtual) antenna groups. The antenna group manager may also perform functionalities related to Tables 1 and 2.

The UE 500 also comprises a resource manager 504. The resource manager 504 decides which control information to send on which resources. The resource manager 504 may also recognize the need to transmit the scheduling request to the eNB. Further, the resource manager 504 may share the resource for the SRI between the antenna groups, or divide the resources of the PUCCH between different antenna groups as explained earlier in connection with FIGS. 3 and 4.

According to an embodiment, the UE 500 further comprises an orthogonalization and modulation (OM) block 506. The OM block 506 performs the orthogonalization of the transmitted sequences from different antenna groups. That is, it may be configured to apply different orthogonal codes to the control information being transmitted from different antenna groups. Further, the OM block 506 performs BPSK, QPSK or similar modulation of the control information data, when needed. Moreover, the OM block 506 may perform CAZAC sequence addition and block-wise spreading with the UE specific spreading factor.

The UE 500 further comprises an interface 508. The interface 508 may perform signal-processing operations for enabling a physical channel connection via antennas 510A to 510D, if needed. The interface 508 may be applied for communication capabilities between the UE 500 and the eNB. The interface 508 may, for example, transmit control information on the PUCCH from multiple antenna groups with spatial transmit diversity, each antenna group comprising one or more antenna elements. The interface 508 may use the virtually grouped antennas in order to generate spatial transmit diversity for the SRI or for the ACK/NACK indicator. Moreover, the interface 508 can use the resources for the SRI or for the ACK/NACK indicator, or both of them depending on the available resources and the need of transmitting the SRI and the ACK/NACK indicator.

The eNB 600 of FIG. 6 comprises an interface 608. The interface 608 may perform signal-processing operations for enabling a physical channel connection via one or more of antennas 610A to 610D, if needed. The interface 608 receives control information on one or more resources of a physical uplink control channel associated with a transmitter. The one or more resources may be received from multiple transmission channels, and an antenna group at the transmitter may transmit information to a transmission channel. The interface may apply one or more antennas 610A to 610D in receiving the control information. The interface 608 may also transmit the uplink scheduling grant to the UE. The interface 608 may further re-transmit downlink data to the transmitter when the received control information on the at least one resource for the ACK/NACK indicator indicates accordingly.

The eNB 606 may also comprise a resource manager 604. The resource manager 604 determines whether specific resources of the physical uplink control channel are occupied with control information, and on whether to schedule the transmitter of the control information for an uplink transmission or not. According to an embodiment, the resource manager 604 schedules the UE for the uplink transmission when the resource for the SRI is occupied with control information. The resource manager 608 may also determine whether at least one resource for the ACK/NACK indicator is occupied with control information or not.

The eNB 600 may further comprise an orthogonalization and demodulation (OD) block 606. The OD block 606 takes care of the demodulation of the control information as well as de-spreading of the received sequence. The control information received from different transmission channels may be affected by orthogonal cover codes and the resource manager 604 may be used in combining the control information on specific resources when the specific resources are occupied with control information. That is, the resources for the SRI may be combined after applying the different orthogonal codes to the different SRI resources, or the resource for ACK/NACK and the resource for the SRI may be combined if both of the resources are occupied with ACK/NACK indicators, as is the case in the embodiment of FIG. 4.

The functional blocks marked with references 502, 504 506, 604 and 606 of the apparatuses in FIGS. 5 and 6 may be realized with one or more processors. The processors may be implemented with separate digital signal processors provided with suitable software embedded on a computer readable medium, or with separate logic circuits, such as application specific integrated circuits (ASIC). The processors may comprise interfaces such as computer ports for providing communication capabilities.

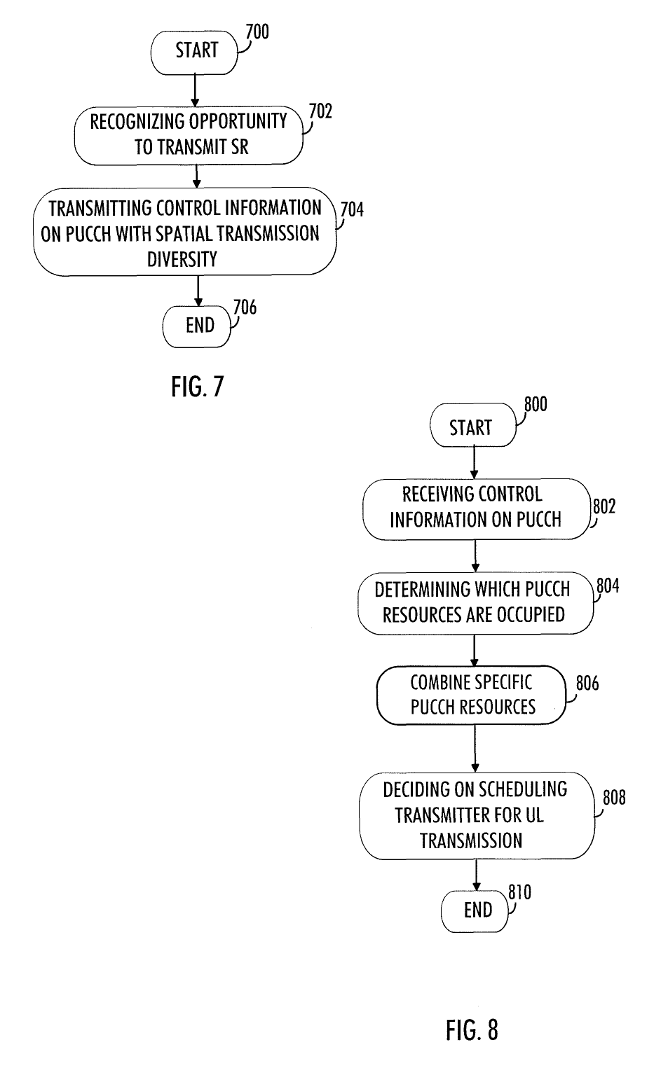

FIG. 7 illustrates a method for transmitting the scheduling request with multiple antennas. The method begins in step 700. In step 702, the method comprises recognizing an opportunity to transmit a scheduling request for an uplink transmission. In step 704, transmitting control information on a physical uplink control channel from multiple antenna groups with spatial transmit diversity takes place, each antenna group comprising one or more antenna elements. The control information may comprise the SRI, either positive SRI or negative SRI. In the case of scheduling request indicator being negative, it may not be transmitted. Further, the control information may comprise the ACK/NACK indicator. The scheduling request may be transmitted via resources for the scheduling request indicator or via the resources for the ACK/NACK indicator. Further, either one of the indicators may be transmitted with spatial transmit diversity. The transmission may indicate the need for an uplink transmission, and also the correctness of the received downlink data. The method ends in step 706.

FIG. 8 shows a method for receiving control information on the physical uplink control channel. The method begins in step 800. Step 802 comprises receiving control information on one or more resources of a physical uplink control channel associated with a transmitter. Step 804 comprises determining whether specific resources of the physical uplink control channel are occupied with control information. That is, the resources for the SRI and for the ACK/NACK indicator may be checked to verify whether there is control information or not. That is, the determination may be performed for multiple resources. For example, the determination may be performed for more than one resource for the ACK/NACK indicator, and for a resource for the SRI. In step 806, the method comprises combining the control information on specific resources when the specific resources are occupied with control information. That is, the resources for the SRI may be combined after applying the different orthogonal codes to the different SRI resources, or the resource for ACK/NACK and the resource for the SRI may be combined if both of the resources are occupied with same control information. The combination in step 806 may be performed prior to step 804, if seen appropriate. Step 808 comprises deciding on whether to schedule the transmitter of the control information for an uplink transmission or not. The scheduling of the transmitter for the uplink transmission may occur when the resource for the SRI is occupied with control information. Further, the determination of whether specific resources of the combined PUCCH are occupied with control information may lead to re-transmitting downlink data to the transmitter when the received control information on the at least one resource for the positive/negative acknowledgement indicator indicates accordingly. The method ends in step 810.

The invention provides several advantages. For instance, the invention increases the coverage, the capacity and the payload of the PUCCH. The PUCCH coverage is increased due to additional spatial diversity gain and the capacity may be increased due to improved link performance (limited interference). Further, the solution is compatible to the release 8. This means that the UEs applying release 8 configurations may co-exist and share the same PUCCH resources as the UEs applying the configurations of the provided solution.

Embodiments of the invention may be implemented as computer programs in the apparatuses of FIGS. 5 and 6, according to the embodiments of the invention. The computer programs implemented in the apparatuses of FIGS. 5 and 6 may carry out, but is not limited to, the tasks related to FIGS. 3 to 8.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but can be modified in several ways within the scope of the appended claims. Further, it is clear to a person skilled in the art that the described embodiments may, but are not required to, be combined with other embodiments in various ways.

1. A method, comprising:
recognizing an opportunity to transmit a scheduling request for an uplink transmission; and
transmitting control information on a physical uplink control channel from multiple antenna groups with spatial transmit diversity, each antenna group comprising one or more antenna elements.

2. The method of claim 1, further comprising:
determining whether there is at least one resource for a positive/negative acknowledgement indicator allocated for transmission or not, the positive/negative acknowledgement indicator indicating the correctness of received downlink data;
transmitting a positive/negative acknowledgement indicator with spatial transmit diversity when the resource for the at least one positive/negative acknowledgement indicator is allocated for transmission; and transmitting a scheduling request indicator with spatial transmit diversity when the resource for the at least one positive/negative acknowledgement indicator is not allocated for transmission, the scheduling request indicator indicating the need for the uplink transmission.

3. The method of claim 1, further comprising:
sharing a resource for the scheduling request indicator between the antenna groups when there is no resource allocated for the positive/negative acknowledgement indicator transmission; and
transmitting the scheduling request indicator from all antenna groups using the shared resource for the scheduling request indicator.

4. The method of claim 1, further comprising:
dividing the resources of the physical uplink control channel such that a resource for the scheduling request indicator is allocated to one antenna group and at least one resource for the positive/negative acknowledgement indicator is allocated to other antenna group when there is at least one resource allocated for the positive/negative acknowledgement indicator transmission; and
transmitting the positive/negative acknowledgement indicator indicating the correctness of the received downlink data by using the resource for the scheduling request indicator from one antenna group indicating the need for the uplink transmission, and by using the at least one resource for the positive/negative acknowledgement indicator from the other antenna group.

5. The method of claim 1, further comprising: applying different orthogonal codes to the control information being transmitted from different antenna groups.

6. The method of claim 1, further comprising:
assigning one or more antennas that belonged to one antenna group in the previous transmission slot to another antenna group for the next transmission slot.

7. The method of claim 1, further comprising:
introducing a phase shift between antenna outputs within an antenna group for predetermined transmission slots, the at least one antenna output to be phase shifted being selected independently for each of the predetermined transmission slots.

8. The method of claim 5, further comprising:
transmitting one positive/negative acknowledgement indicator by using a predetermined resource for the positive/negative acknowledgement indicator from one antenna group indicating the correctness of the received downlink data, and other positive/negative acknowledgement indicator by using a resource for the scheduling request indicator from other antenna group indicating the correctness of the received downlink data and the need for the uplink transmission, when the positive/negative acknowledgement indicator occupies multiple resources.

9. The method of claim 5, further comprising: transmitting the positive/negative acknowledgement indicator by using at least one resource for the positive/negative acknowledgement indicator from at least one antenna group, when the scheduling request indicator is not transmitted.

10. A method, comprising:
receiving control information from one or more resources of a physical uplink control channel associated with a transmitter;
determining whether specific resources of the physical uplink control channel are occupied with control information;
combining the control information from the specific resources when the specific resources are occupied with control information; and
deciding on whether to schedule the transmitter for an uplink transmission or not, when a resource for a scheduling request indicator is occupied with control information.

11. The method of claim 10, further comprising:
combining the control information on at least one of the following resources: the resources for the scheduling request indicator and the resources for a positive/negative acknowledgement indicator.

12. The method of claim 10, further comprising:
re-transmitting downlink data to the transmitter when the at least one resource for the positive/negative acknowledgement indicator is occupied with control information indicating accordingly.

13. The method of claim 10, further comprising:
re-transmitting downlink data to the transmitter when each of the at least one allocated resources for the positive/negative acknowledgement is empty.

14. An apparatus, comprising:
a processor configured to recognize an opportunity to transmit a scheduling request for an uplink transmission; and
an interface configured to transmit control information on a physical uplink control channel from multiple antenna groups with spatial transmit diversity, each antenna group comprising one or more antenna elements.

15. The apparatus of claim 14, wherein the processor is further configured to determine whether there is at least one resource for a positive/negative acknowledgement indicator allocated for transmission or not, the positive/negative acknowledgement indicator indicating the correctness of received downlink data; and the interface is further configured to:
transmit a positive/negative acknowledgement indicator with spatial transmit diversity when the resource for the at least one positive/negative acknowledgement indicator is allocated for transmission; and to
transmit a scheduling request indicator with spatial transmit diversity when the resource for the at least one positive/negative acknowledgement indicator is not allocated for transmission, the scheduling request indicator indicating the need for the uplink transmission.

16. The apparatus of claim 14, wherein the processor is further configured to share a resource for the scheduling request indicator between the antenna groups in the case when there is no resource allocated for the positive/negative acknowledgement indicator transmission; and
the interface is further configured to transmit the scheduling request indicator from all antenna groups using the shared resource for the scheduling request indicator.

17. The apparatus of claim 14, wherein the processor is further configured to divide the resources of the physical uplink control channel such that a resource for the scheduling request indicator is allocated to one antenna group and at least one resource for the positive/negative acknowledgement indicator is allocated to other antenna group when there is at least one resource allocated for the positive/negative acknowledgement indicator transmission; and the interface is further configured to:
transmit the positive/negative acknowledgement indicator indicating the correctness of the received downlink data by using the resource for the scheduling request indicator from one antenna group indicating the need for the uplink transmission, and by using the at least one resource for the positive/negative acknowledgement indicator from the other antenna group.

18. The apparatus of claim 14, wherein the processor is further configured to apply different orthogonal codes to the control information being transmitted from different antenna groups.

19. The apparatus of claim 14, wherein the processor is further configured to assign one or more antennas that belonged to one antenna group in the previous transmission slot to another antenna group for the next transmission slot.

20. The apparatus of claim 14, wherein the processor is further configured to introduce a phase shift between antenna outputs within an antenna group for predetermined transmission slots, the at least one antenna output to be phase shifted being selected independently for each of the predetermined transmission slots.

21. The apparatus of claim 18, wherein the interface is further configured to transmit one positive/negative acknowledgement indicator by using a predetermined resource for the positive/negative acknowledgement indicator from one antenna group indicating the correctness of the received downlink data, and other positive/negative acknowledgement indicator by using a resource for the scheduling request indicator from other antenna group indicating the correctness of the received downlink data and the need for the uplink transmission, when the positive/negative acknowledgement indicator occupies multiple resources.

22. The apparatus of claim 18, wherein the interface is further configured to transmit the positive/negative acknowledgement indicator by using at least one resource for the positive/negative acknowledgement indicator from at least one antenna group, when the scheduling request indicator is not transmitted.

23. An apparatus, comprising:
an interface configured to receive control information from one or more resources of a physical uplink control channel associated with a transmitter; and a processor configured to:
determine whether specific resources of the physical uplink control channel are occupied with control information;
combine the control information on the specific resources when the specific resources are occupied with control information; and
decide on whether to schedule the transmitter for an uplink transmission or not, when a resource for a scheduling request indicator is occupied with control information.

24. The apparatus of claim 23, wherein the processor is further configured to combine the control information on at least one of the following resources: the resources for the scheduling request indicator and the resources for a positive/negative acknowledgement indicator.

25. The apparatus of claim 23, wherein the interface is further configured to re-transmit downlink data to the transmitter when the at least one resource for a positive/negative acknowledgement indicator is occupied with control information indicating accordingly.

26. The apparatus of claim 23, wherein the interface is further configured to re-transmit downlink data to the transmitter when each of the at least one allocated resources for the positive/negative acknowledgement is empty.

27. An apparatus, comprising:
processing means for recognizing an opportunity to transmit a scheduling request for an uplink transmission; and
means for transmitting control information on a physical uplink control channel from multiple antenna groups with spatial transmit diversity, each antenna group comprising one or more antenna elements.

28. An apparatus, comprising:
means for receiving control information from one or more resources of a physical uplink control channel associated with a transmitter;
processing means for determining whether specific resources of the physical uplink control channel are occupied with control information;
processing means for combining the control information on the specific resources when the specific resources are occupied with control information; and
processing means for deciding on whether to schedule the transmitter of the control information for an uplink transmission or not, when a resource for a scheduling request indicator is occupied with control information.

29. A computer program product, embodied on a computer-readable storage medium and comprising a program code which, when run on a processor, executes the method comprising:
recognizing an opportunity to transmit a scheduling request for an uplink transmission; and
controlling the transmission of control information on a physical uplink control channel from multiple antenna groups with spatial transmit diversity, each antenna group comprising one or more antenna elements.

30. A computer program product, embodied on a computer-readable storage medium and comprising a program code which, when run on a processor, executes the method comprising:
controlling the reception of control information from one or more resources of a physical uplink control channel associated with a transmitter;
determining whether specific resources of the physical uplink control channel are occupied with control information;
combining the control information on the specific resources when the specific resources are occupied with control information; and
deciding on whether to schedule the transmitter of the control information for an uplink transmission or not, when a resource for a scheduling request indicator is occupied with control information.
